(19) United States
(12) Patent Application Publication
(10) Pub. No.: US 2012/0177336 A1
(43) Pub. Date: Jul. 12, 2012

(54) CROSSING ARM FOR SCHOOL BUS SYSTEMS

(76) Inventor: Heidi Bhan, Eugene, OR (US)

(21) Appl. No.: 13/330,928

(22) Filed: Dec. 20, 2011

Related U.S. Application Data
(60) Provisional application No. 61/430,563, filed on Jan. 7, 2011.

(51) Int. Cl. H04N 5/77; H04N 7/18

(52) U.S. Cl. 386/224; 348/148; 348/E07.085

(57) ABSTRACT

A school bus safety assembly useful for stopping approaching vehicles, and detecting, displaying, and recording school bus stop arm violations comprising: a movable arm situated on a driver's side of a school bus, an electric motor for deploying the movable arm, a camera device, an image storage device, and an image display device. The movable arm is designed to indicate to approaching vehicles to stop and is deployable from a retracted position to an extended position via the electric motor. The camera device is mounted on the movable arm and is connected to the image storage device and to the image display device which are situated on an inside of the school bus in a vicinity of a seat of a driver. The school bus safety assembly operates in conjunction with a stop arm but is physically separated a distance from the stop arm.

### CROSS-REFERENCE TO RELATED APPLICATION

The present application is related to and claims priority from prior provisional application Ser. No. 61/430,563, filed Jan. 7, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of crossing arms for use on a school bus and more specifically relates to the combination of a crossing arm for a school bus and a device for detecting, displaying, and recording school bus stop arm violations.

2. Description of the Related Art

Children are at greatest risk for accidents when they are getting onto or off of a school bus with many of these children getting hurt in bus-related crashes being pedestrians. Accidents occur near the school bus when passing motorists ignore the flashing red warning lights and disregard the school bus stop arms. Therefore most states have laws making the passing of a stopped school bus illegal.

The reason for these traffic law violations might be that some drivers are just not well informed about the requirements of the law. Many drivers are not aware of their responsibilities under the law and might be confused about the law regarding stopping for school buses. Some motorists might choose to ignore the law because they are in a hurry. Distraction might also play a key factor in failing to follow the stop-arm law. Many drivers simply do not see the stopped school bus until it is too late.

This may be the case because the safety devices included on the outer surfaces of school buses may not be sufficient. Flashing lights and deployed stop signs may not be enough to deter impatient or oblivious drivers from coming too close to school buses that have stopped to pick up or drop off children. Unfortunately most school busses are not equipped with a system that prevents vehicles from coming to close to children who are entering or exiting a school bus along with monitoring and recording vehicles in the vicinity of the school bus.

Therefore a need exists for a reliable combination of a crossing arm for a school bus and a device for detecting, displaying, and recording school bus stop arm violations. A further need exists for a crossing arm and camera combination which creates a physical barrier for approaching vehicles and at the same time monitors such approaching vehicles.

Various attempts have been made to solve the above-mentioned problems such as those found in U.S. Pat. and U.S. Pub. Nos. 6,738,089; 5,281,948; 2003/0070603; 5,038,136; 6,213,047; and 5,406,251. This prior art is representative of crossing arms for use on a school bus. None of the above inventions and patents, taken either singly or in combination, is seen to describe the invention as claimed.

Ideally, a combination of a crossing arm for a school bus and a device for detecting, displaying, and recording school bus stop arm violations should be easy to use, easy to install and maintain, operate reliably, and be manufactured at a modest expense. Thus, a need exists for a reliable school bus crossing arm system for controlling traffic near a school bus and for detecting, displaying, and recording school bus stop arm violations and to avoid the above-mentioned problems.

### BRIEF SUMMARY OF THE INVENTION

In view of the foregoing disadvantages inherent in the known crossing arms for use on a school bus art, the present invention provides a novel Crossing Arm for School Bus System. The general purpose of the present invention, which will be described subsequently in greater detail, is to provide a combination of a crossing arm for a school bus and a device for detecting, displaying, and recording school bus stop arm violations.

A school bus safety assembly is disclosed herein comprising: a movable arm, an electric motor for deploying/returning the movable arm, a camera device, an image storage device, and an image display device.

The movable arm is designed to indicate to approaching vehicles to stop and is deployable from a retracted position to an extended position via the electric motor. The camera device is mounted on the movable arm (rearwardly-facing so as to directly face the driver of the vehicle—acting as both a visual deterrent and as an enforcing means) and is connected to the image storage device and to the image display device which are situated on an inside of the school bus in a vicinity of a seat of a driver. The school bus safety assembly operates in conjunction with a stop arm but is physically separated a distance from the stop arm (so as to act as redundant systems and further to decrease weight on the movable arm). The school bus safety assembly is useful for stopping approaching vehicles, and detecting, displaying, and recording school bus stop arm violations.

A kit is also described herein including at least one movable arm, an electric motor, a camera device, an image storage device, and an image display device.

A preferred method of use is further disclosed herein comprising the following steps: bringing a school bus to a stop, deploying a movable arm situated on a driver's side of the school bus, capturing images of traffic approaching the movable arm via a camera device mounted on the movable arm, monitoring the images of the traffic approaching the movable arm via an image display device which is connected to the camera device and situated on the inside of the school bus, storing the images of the traffic approaching the movable arm with an image storage device which is connected to the camera device and situated on an inside of the school bus, and using the images of the traffic for further investigation in the event of a traffic violation.

The present invention holds significant improvements and serves as a Crossing Arm for School Bus System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Crossing Arm for School Bus Systems, constructed and operative according to the teachings of the present invention.

FIG. 1 shows a perspective view illustrating a school bus safety assembly according to an embodiment of the present invention.

FIG. 2 is a perspective view illustrating a camera device according to an embodiment of the present invention.

FIG. 3 is a perspective view illustrating an image display device according to an embodiment of the present invention.

FIG. 4 is a perspective view illustrating the school bus safety assembly in an in-use condition according to an embodiment of the present invention of FIG. 1.

FIG. 5 is a flowchart illustrating a method of using the school bus safety assembly according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a school bus safety assembly and more particularly to a device useful for stopping approaching vehicles, and detecting, displaying, and recording school bus stop arm violations.

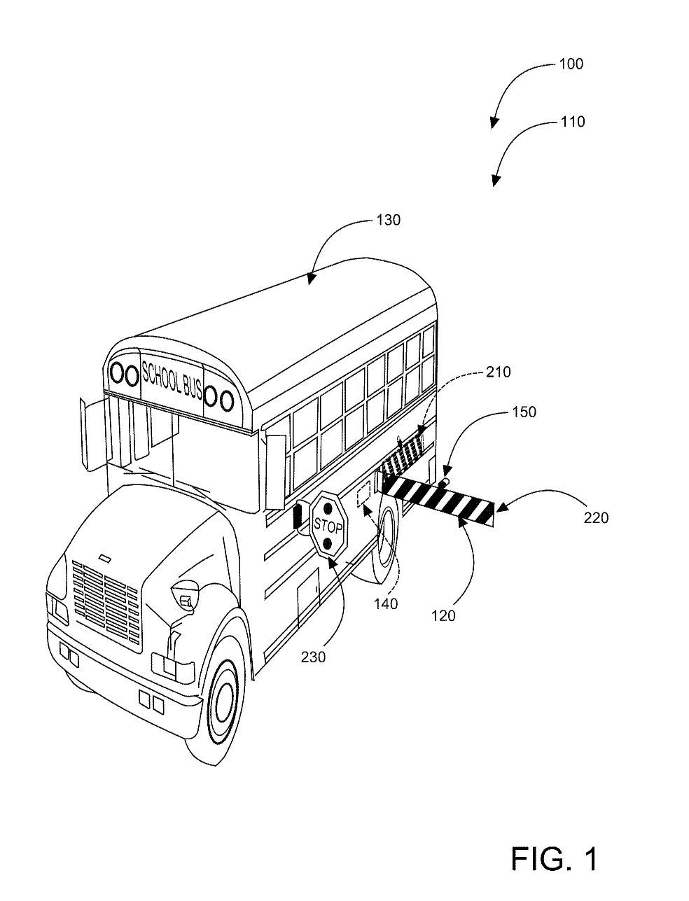

Referring to the drawings by numerals of reference there is shown in FIG. 1, a perspective view illustrating school bus safety assembly 110 according to an embodiment of the present invention.

School bus safety assembly 110 preferably comprises: movable arm 120 situated on a driver's side of school bus 130, electric motor 140 for deploying movable arm 120, camera device 150, image storage device 160, and image display device 170. School bus safety assembly 110 may be manufactured and sold separately as an add on unit for school busses or other vehicles which typically are approached by children or other pedestrians, such as ice cream trucks, etc. School bus safety assembly 110 permits the detection and identification of cars moving towards extended movable arm 120 of school bus 130 when children may be entering or exiting school bus 130.

Movable arm 120 is designed to indicate to approaching vehicles 180 to stop and also is designed to act as a deterrent and physical barrier to approaching vehicles 180. Movable arm 120 is preferably made of lightweight, durable and weatherproof material, such as plastic. Movable arm 120 therefore may be manufactured at a modest expense. However, movable arm 120 may comprise any other suitable material, such as wood, aluminum, etc. Movable arm 120 preferably is marked with prominent red and white stripes 190 so as to be easily recognized by approaching vehicles 180. Flashing lights may be mounted on movable arm 120 so as to further attract the attention of drivers of approaching vehicles 180.

Movable arm 120 preferably is situated on the driver's side of school bus 130 midway along the length of school bus 130, and at an appropriate height to deter approaching vehicles 180 from overtaking school bus 130. Approaching vehicles 180 that do not stop may hit movable arm 120 before impacting children, which therefore may reduce the chance of injury. Movable arm 120 may be attached to school bus 130 via any suitable and inexpensive mounting mechanism. The mounting mechanism may comprise a swivel or hinge such that trigger switch 200 positioned inside school bus 130 may allow a driver to actuate movable arm 120 between retracted position 210 and extended position 220. However, any mounting means may be used that may make movable arm 120 move between retracted position 210 and extended position 220.

Movable arm 120 preferably is deployable from retracted position 210 to extended position 220 via electric motor 140. Movable arm 120 may be rotated about a vertical axis so as to lie flat against school bus 130 when it is in retracted position and is rotated 90 degrees so that movable arm 120 faces approaching vehicles 180 when in extended position 220. As school bus 130 reaches a stop, movable arm 120 may be deployed, and flashing lights may start flashing. Movable arm 120 is of sufficient length to reach across a width of a street lane when movable arm 120 is in extended position 220. Movable arm 120 may operate in conjunction with stop arm 230 yet is physically separated from stop arm 230. Movable arm 120 may also be operated independently from stop arm 230.

Movable arm 120 may be approximately xx inches long×xx inches wide×xx inches thick, however it should be appreciated that other heights and diameters will fall within the scope and spirit of the invention as described herein, and that any references to sizes, heights, weights are exemplary, and are not to be construed as limiting in any way. Since flashing lights and deployed stop signs may not be enough to deter impatient or oblivious drivers from coming too close to school buses that have stopped to pick up or drop off children, movable arm 120 provides an effective additional deterrent which physically hinders approaching vehicles 180 from getting too close to pedestrians which are in the vicinity of school bus 130. Movable arm 120 alerts motorists that children are either entering or exiting school bus 130 so that approaching vehicles 180 may stop a sufficient distance from movable arm 120 so as to allow children or pedestrians to cross the street if necessary.

School bus safety assembly 110 further comprises electric motor 140 for deploying movable arm 120. Electric motor 140 preferably is operated with trigger switch 200 which is situated in the vicinity of the seat of the driver. Therefore movable arm 120 is preferably operated by an electrically operated system. However, movable arm 120 may be operated by any suitable system, such as for example a pneumatic system. Electric motor 140 preferably may be powered by a self-contained battery. Movable arm 120 may be retracted (folded inwardly or upwardly) into a position adjacent to the school bus body (exterior shell.)

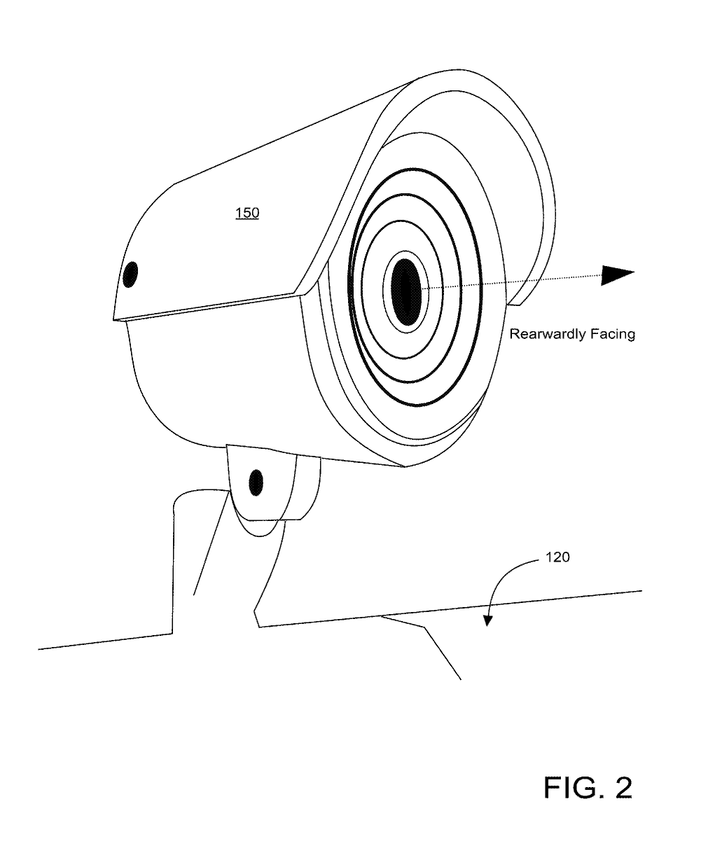

Referring now to FIG. 2, a perspective view illustrating camera device 150 according to an embodiment of the present invention.

School bus safety assembly 110 further comprises camera device 150. Camera device 150 is mounted on movable arm 120 in a rearward facing manner and also perpendicular to movable arm 120. Camera device 150 may be a camera of any type such as a video camera or a digital still camera and therefore may be manufactured at a modest expense. Camera device 150 preferably faces in one direction, which is towards approaching vehicles 180. Camera device 150 is situated within a view of approaching vehicles 180 and acts as a visual deterrent. Upon seeing camera device 150 approaching drivers will be immediately aware that there is a camera directed towards them, will drive more carefully and will bring their cars to a halt in front of movable arm 120. Camera device 150 therefore acts as deterrent even when not functioning or in an off-position. Camera device 150 preferably is removably mounted on movable arm 120 via screws or other suitable mounting mechanisms.

Camera device 150 is used to capture images of cars as they approach movable arm 120. Camera device 150 may be activated and controlled by bus driver actuated control 240 and begins acquiring images or video of an area in proximity to movable arm 120 as soon as camera device 150 is activated by the bus driver. Alternatively, camera device 150 may be activated automatically by control 240 as soon as movable arm 120 is in extended position 220. The area filmed by camera device 150 may be a wide-angle rear view of the area behind movable arm 120. Camera device 150 may preferably be adapted for acquiring continuous video during a duration in which movable arm 120 is in extended position 220. However camera device 150 may also be a still camera and may be able to take photos of approaching vehicles 180. Camera device 150 may stop acquiring (still) images or video as soon as camera device 150 is deactivated by the bus driver. Alternatively, camera device 150 may be deactivated automatically by control 240 as soon as movable arm 120 is in retracted position 210. Camera device 150, as located, acts as a visual deterrent since a driver is acutely aware that he/she will be photographed or recorded for infractions.

Therefore, when a car is approaching movable arm 120, a video of the car including the license plate number and the driver is recorded. Alternatively, pictures of the car including the license plate number and the driver may be taken. After that, in case the driver committed a stop-arm violation, the car and the driver may be identified. As mentioned before, camera device 150 is connected to and operable via control 240 situated in the vicinity of the seat of the driver. Camera device 150 is further connected to image storage device 160. Image storage device 160 is situated on the inside of school bus 130 in the vicinity of the seat of the driver and preferably comprises a digital video recorder. However, image storage device 160 may comprise any suitable data storage device, such as a DVD recorder.

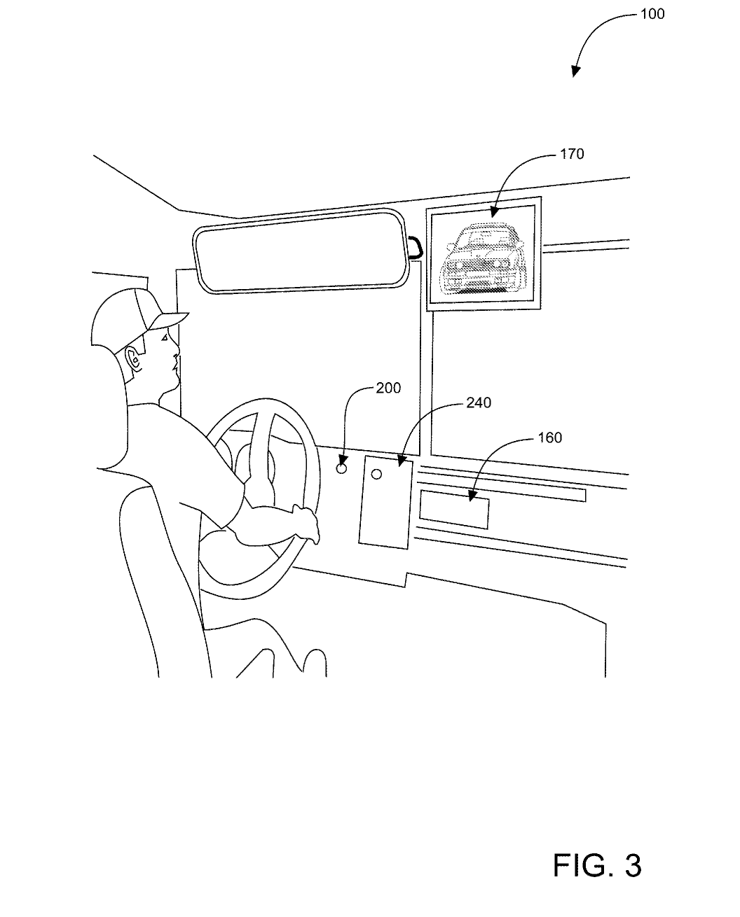

Referring now to FIG. 3, a perspective view illustrating image display device 170 according to an embodiment of the present invention.

School bus safety assembly 110 further comprises image display device 170. Image display device 170 is situated on the inside of school bus 130 in the vicinity of the seat of the driver. Image display device 170 preferably comprises a display screen. Image display device 170 therefore provides the driver with a view of real-time images being recorded by camera device 150. Driver therefore may use image display device 170 to monitor traffic which is approaching movable arm 120.

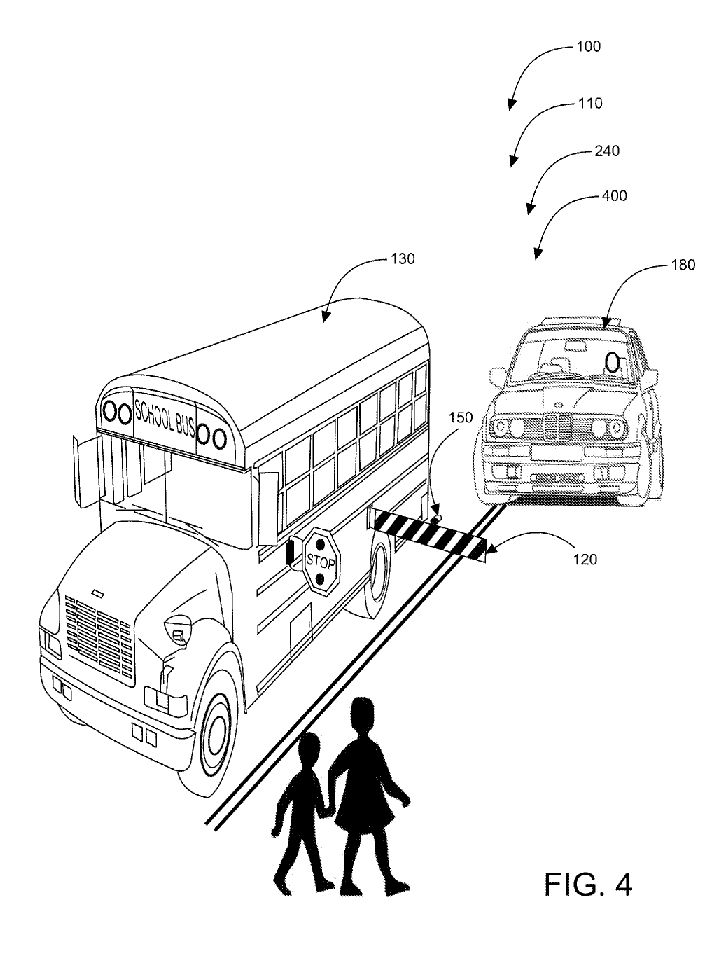

Referring now to FIG. 4, showing a perspective view illustrating school bus safety assembly 110 in in-use condition 250 according to an embodiment of the present invention of FIG. 1. FIG. 4 shows school bus 130 parked and ready to load or unload passengers. Approaching vehicle 180 is shown in an oncoming lane of traffic, stopping in front of movable arm 120.

As soon as school bus 130 comes to a halt, movable arm 120, which is situated on the driver's side of school bus 130 may be deployed by driver via electric motor 140 which preferably is operated with trigger switch 200 situated in the vicinity of the seat of the driver. Camera device 150 which is mounted on movable arm 120 may be used to capture images of approaching vehicles 180 and may be used in combination with movable arm 120 as a deterrent so as to stop approaching vehicles 180. Image display device 170 may be connected to camera device 150 and may be situated on an inside region of school bus 130 so that bus driver is able to monitor approaching vehicles 180. Image storage device 160 may be used to temporarily store images of traffic approaching movable arm 120. After that the stored images of traffic may be used for further investigation in the event of a traffic violation.

Crossing Arm for School Bus Systems 100 may be sold as kit 400 comprising the following parts: at least one movable arm 120; at least one electric motor 140; at least one camera device 150; at least one image storage device 160; at least one image display device 170; and at least one set of user instructions.

Crossing Arm for School Bus Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

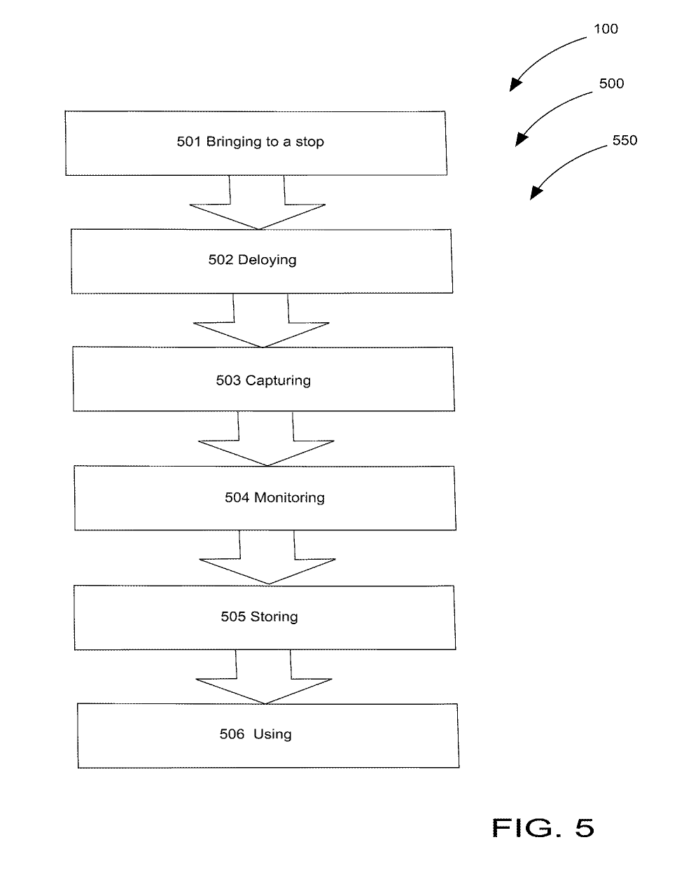

Referring now to FIG. 5, flowchart 550 illustrating a method 500 of using school bus safety assembly 110 according to an embodiment of the present invention of FIG. 1.

In accordance with the embodiments of the present invention a preferred method of use 500 is disclosed herein comprising: step one 501 bringing school bus 130 to a stop; step two 502 deploying movable arm 120 situated on a driver's side of school bus 130; step three 503 capturing images of traffic approaching movable arm 120 via camera device 150 mounted on movable arm 120; step four 504 monitoring images of traffic approaching movable arm 120 via image display device 170 which is connected to camera device 150 and situated on the inside of school bus 130; step five 505 storing images of traffic approaching movable arm 120 with image storage device 160 which is connected to camera device 150 and situated on an inside of school bus 130; and step six 506 using images of traffic for further investigation in the event of a traffic violation.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed new and desired to be protected by Letters Patent is set forth in the appended claims:

1. A school bus safety assembly comprising:
a movable arm situated on a driver's side of a school bus;
an electric motor for deploying said movable arm;
a camera device;
an image storage device; and
an image display device;
wherein said movable arm is designed to indicate to approaching vehicles to stop;
wherein said movable arm is deployable from a retracted position to an extended position via said electric motor;
wherein said camera device is mounted on said movable arm;
wherein said camera device is connected to said image storage device and to said image display device; said image storage device and said image display device being situated on an inside of said school bus in a vicinity of a seat of a driver;
wherein said school bus safety assembly operates in conjunction with a stop arm but is physically separated a distance from said stop arm; and
wherein said school bus safety assembly is useful for stopping said approaching vehicles, and detecting, displaying, and recording school bus stop arm violations.

2. The school bus safety assembly of claim 1 wherein said movable arm is marked with prominent red and white stripes.

3. The school bus safety assembly of claim 1 wherein flashing lights are mounted on said movable arm.

4. The school bus safety assembly of claim 1 wherein said movable arm is situated on said driver's side of said school bus midway along the length of said school bus and at an appropriate height to deter said approaching vehicles from overtaking said school bus.

5. The school bus safety assembly of claim 1 wherein said movable arm is of sufficient length to reach across a width of a street lane when said movable arm is in said extended position.

6. The school bus safety assembly of claim 1 wherein said electric motor is operated with a trigger switch situated in said vicinity of said seat of said driver.

7. The school bus safety assembly of claim 1 wherein said camera device is mounted on said movable arm and is operable via a control situated in said vicinity of said seat of said driver.

8. The school bus safety assembly of claim 1 wherein said camera device is mounted on said movable arm in a rearward facing manner and perpendicular to said movable arm.

9. The school bus safety assembly of claim 1 wherein said camera device faces in one direction.

10. The school bus safety assembly of claim 1 wherein said camera device is situated within a view of said approaching vehicles and acts as a visual deterrent.

11. The school bus safety assembly of claim 1 wherein said camera device is adapted for acquiring continuous video during a duration in which said movable arm is in said extended position.

12. The school bus safety assembly of claim 1 wherein said camera device is mounted on said movable arm and is used to capture images of said vehicles as they approach said movable arm.

13. The school bus safety assembly of claim 1 wherein said image storage device is situated on said inside of said school bus in said vicinity of said seat of said driver and comprises a digital video recorder.

14. The school bus safety assembly of claim 1 wherein said image storage device comprises a DVD recorder.

15. The school bus safety assembly of claim 1 wherein said image display device comprises a screen which is situated on said inside of said school bus in said vicinity of said seat of said driver.

16. A school bus safety assembly comprising:
a movable arm situated on a driver's side of a school bus;
an electric motor for deploying said movable arm;
a camera device;
an image storage device; and
an image display device;
wherein said movable arm is designed to indicate to approaching vehicles to stop;
wherein said movable arm is deployable from a retracted position to an extended position via said electric motor which is operated with a trigger switch situated in a vicinity of a seat of a driver;
wherein said camera device is mounted on said movable arm, faces in one direction, and is operable via a control situated in said vicinity of said seat of said driver, and is used to capture images of said vehicles as they approach said movable arm and to act as a visual deterrent;
wherein said camera device is connected to said image storage device and to said image display device; said image storage device and said image display device being situated on an inside of said school bus in said vicinity of said seat of said driver;
wherein said school bus safety assembly operates in conjunction with a stop arm but is physically separated a distance from said stop arm; and
wherein said school bus safety assembly is useful for stopping said approaching vehicles, and detecting, displaying, and recording school bus stop arm violations.

17. The school bus safety assembly of claim 16 wherein said school bus safety assembly comprises a kit comprising said movable arm, said electric motor, said camera device, said image storage device, and said image display device.

18. A method of using a school bus safety assembly comprising the steps of:
bringing a school bus to a stop;
deploying a movable arm situated on a driver's side of said school bus;
capturing images of traffic approaching said movable arm via a camera device mounted on said movable arm;
monitoring said images of said traffic approaching said movable arm via an image display device which is connected to said camera device and situated on an inside of said school bus;
storing said images of said traffic approaching said movable arm with an image storage device which is connected to said camera device and situated on said inside of said school bus; and
using said images of said traffic for further investigation in the event of a traffic violation.
